(19) United States
(12) Patent Application Publication
(10) Pub. No.: US 2017/0022979 A1
(43) Pub. Date: Jan. 26, 2017

(54) Emergency system

(71) Applicant: HA-PA HOLDING A/S, Sydals (DK)

(72) Inventor: Paul Teichert, Sydals (DK)

(21) Appl. No.: 15/039,675

(22) PCT Filed: Dec. 1, 2014
(86) PCT No.: PCT/DK2014/050409

§ 371 Date: May 26, 2016

(30) Foreign Application Priority Data
Nov. 29, 2013 (DK) PA 2013 00669

(51) Int. Cl. F03D 80/00; B66B 7/02; B66B 11/06; B66B 9/00; F03D 1/00; B66B 11/02

(52) U.S. Cl. CPC F03D 80/00; F03D 1/003; B66B 11/02; B66B 11/06; B66B 9/00; B66B 7/02; F05B 2240/916

(57) ABSTRACT

Emergency system for providing an emergency exit from an upper level at a wind turbine (1) comprising at least a wind turbine tower (2) and a nacelle (3), said emergency system (10) comprising —an escape unit (12), which in a normal condition is releasably located at a position at the nacelle of the wind turbine, —said escape unit (12) comprising lowering means, —said escape unit being adapted for accommodating at least one person, —said escape unit comprising releasing means for providing a release from said position at said upper level and for allowing said escape unit (12) to be lowered downwards by means of said lowering means to a lower level of said wind turbine, and —said emergency system (10) further comprising initial guiding means and tower guide means for facilitating guidance of said escape unit (12) in relation to the wind turbine tower (2).

### FIELD OF THE INVENTION

The present invention relates to an emergency system for providing an emergency exit from an upper level at a wind turbine such as from the nacelle or from a top level of the wind turbine tower.

The invention further relates to a method of performing an emergency exit from an upper level of a wind turbine using such an emergency system.

### BACKGROUND OF THE INVENTION

Within the field of wind turbines an increasing number of accidents involving e.g. fire or the like have shown to take place. As the number of wind turbines in operation is increasing, it may be expected that these accident numbers will continue to increase. Factors such as an increasing (average) age of many operating wind turbines might be expected to influence the accident numbers, but also fire accidents etc. involving new and relatively new wind turbines are increasing in numbers. In wind turbines there have been implemented various measures to reduce e.g. fire risk, for example by including fire extinguishing systems, but in spite of this fire incidents and accidents occur at an increasing rate in wind turbines. Such accidents naturally lead to damages to components in the wind turbine and even to essentially total damages to e.g. the nacelle, the rotor blades, etc., within a relatively short time after a fire has started, e.g. due to the inflammable materials present in the nacelle, including inflammable liquids such as hydraulic liquids, oil products, etc., due to the electric and electronic equipment and components in general, and due to the materials in the rotor blades, which damages in itself are unfortunate.

But even more disastrous is it, if persons are involved in such accidents, e.g. in particular in case one or more person is/are present in the wind turbine, for example being in the process of servicing the wind turbine components in/on the nacelle, the rotor blade components, components in the top of the wind turbine tower, or the like. In such cases it may be difficult for the person or persons to escape from e.g. the nacelle, since the natural and usual way down, e.g. through a floor hatch in the nacelle down to the tower, may be impossible to use because of e.g. fire, smoke, heat, etc. and in any case such an escape route may be too troublesome to use and may not provide a sufficiently speedy escape.

In this connection it is noted that normally at least two service persons will be present in the wind turbine during service work, etc. (e.g. due to safety rules, etc.) and that in several situations as many as 4-10 persons or even more may be present at the same time in the wind turbine, particularly in the larger wind turbines, during service, repair, etc. since it is of importance to minimize the standstill of the wind turbine. In case of an emergency it is of importance that all persons present in the wind turbine can be evacuated effectively and quickly. This is accentuated by the fact that fire accidents in wind turbines have shown to evolve very quickly, e.g. within a relatively short timeframe of around 3-4 minutes. Thus, it is very important to be able to escape quickly. This is, however, in many instances prohibited due to the high levels involved and the remote locations of the wind turbines, in particular at sea. This also makes fire extinguishing using traditional fire trucks or the like impossible and naturally also makes it in practice impossible to rescue persons using such traditional fire truck material.

In recent years a number of wind turbine accidents, in particular fire accidents, have occurred, where persons have been injured or even lost their life because they have not been able to escape from an upper level of a wind turbine, e.g. from the nacelle or the top of the wind turbine tower.

Methods and systems for evacuation of persons from wind turbines in case of fire have previously been suggested.

As an example, WO 2012160038 A2 discloses a rescue method and a rescue device for a wind turbine, where a descend rope is lowered down via a hatch in the bottom of the rear end of the nacelle. When the rope has been lowered completely, e.g. with the end below the surface of the sea or at the ground, a counterweight is subsequently lowered down along the rope in a controlled manner. The counterweight may be combined with a rescue boat. Subsequently, the service persons in the nacelle may one by one slide down the descend rope, each of the persons using a slide/braking device.

According to this prior art, the persons in the nacelle will have to wait for the descend rope to be lowered down to e.g. sea level and for the counterweight to be released and lowered at least part of the way down to the sea level, before the first person can initiate the descend downwards along the rope. Since it may be considered that in connection with a wind turbine, where the nacelle is positioned at a level of 100 meters or more above sea level, it will take around 5 minutes or more before the descend rope is lowered down to sea level, and since furthermore the counterweight has to be released and lowered at least part of the way down to the sea level, before the first person can initiate the descend downwards according to this prior art, it will be understood that a fire can have reached an extensive proportion (cf. the above-mentioned 3-4 minutes), before the first person can begin the escape, not to mention the following persons, which may all be harmed by the fire, the heat, potentially toxic smoke and gases, etc. Thus, the fire may have evolved considerably, before the first person in line can begin the escape, and considerable further time will have lapsed, before the last person has reached the sea level.

Further, it is noted that on the downwards slide, the persons sliding down the rope will be subjected to e.g. the wind and in stormy conditions they may collide with e.g. the wind turbine tower, even though the counterweight is used, whereby dangerous situations may arise and whereby the persons may be (further) injured. Furthermore, on the downwards slide, the persons are unprotected and may be subjected to material falling down due to the fire, e.g. hot or glowing debris, etc. Also, it is noted that the persons being rescued according to this prior art will end either on the ground or in the sea, possibly in a relatively small rescue boat, where they will be subjected to the surrounding conditions, e.g. the wind, the sea, rain, etc. In this connection it will be realized that some of the person may have suffered injuries due to e.g. the fire and may require treatment, wherefore it is less than optimal that after the descent they will be relatively unprotected.

Also, when the persons are being brought down into the sea, no matter whether it is in a small rescue boat or not, the persons may subsequently collide with e.g. the off shore wind turbine foundation due to current, waves and or wind, etc. and may thus be subjected to further hazards, injuries and danger. In this connection it must be considered that due to the long distances to shore, it may take a long time, before e.g. rescue vessels, boats etc. can arrive, which further increases the hazardous situation.

Also, it is noted that in case one or more of the persons in the nacelle have been injured, e.g. having sustained head injury, spine injury, burn injury, heart attack, etc. it may be very difficult or completely impossible for such a person to escape via the rescue method and device as proposed according to this prior art.

In this connection it is noted that in general the service persons working in the wind turbine, e.g. in the nacelle and/or in the upper part of the tower, are normally wearing only normal, light work clothes, e.g. since the temperature in the nacelle is not abnormal. Further, additional clothing, etc. is normally not available, and thus it has to be considered that such normally clad persons are not able to sustain longer periods subjected to wind, cold, rain, etc. and particularly not a stay in the sea, even if it is in a rescue boat. To this comes that some of the persons may have been harmed or injured, which furthermore will worsen the situation.

Further, EP 1 624 186 A2 discloses a rescue capsule for an off-shore wind turbine, where the rescue capsule is placed in the rear end of the nacelle. In case of fire, service persons in the nacelle can open a hatch in the rescue capsule and enter the rescue capsule. The rescue capsule has a drum with a line that is connected to the nacelle. When a locking mechanism is released, the rescue capsule is released from the nacelle and moves downwards to the sea, while the line is rolled out from the drum that may be brake-controlled to control the descent.

The rescue capsule may be stopped just above the surface of the sea or it may end in the sea, where the persons inside will have to wait for rescue personnel.

It is noted that in case the rescue capsule is stopped just above the surface of the sea, an evacuation from the rescue capsule must presumably be performed relatively quickly, since the line that is connected to the nacelle will be harmed by the fire and the resulting high temperatures, e.g. reaching melting or at least potential weakening temperatures for metals, in the nacelle and may break/burn. Similar regards the e.g. fixing point in the nacelle, to which the line is attached, which after some time can be expected to fail. Thus, the rescue capsule can be expected to end in the sea according to this prior art, whether or not it is stopped above the sea level.

In both instances, whether or not rescue capsule is stopped above the sea level, the capsule and the persons inside will have to endure the conditions until rescue personnel arrives, which may be less than optimal, e.g. in case it is in windy or stormy conditions and in case (some of) the persons have been injured due to the fire. As mentioned above, these conditions are worsened by the fact that the persons will normally wear only normal working clothes and not clothes suitable for conditions in the sea, subjected to wind, cold, rain, seawater, etc.

Also, when the persons are being brought down into the sea, even though it is in a rescue capsule, the rescue capsule and the persons may subsequently collide with e.g. the off shore wind turbine foundation due to current, waves and or wind, etc. and may thus be subjected to further hazards, injuries and danger. In this connection it must be considered that due to the long distances to shore, it may take a long time, before e.g. rescue vessels, boats etc. can arrive, which further increases the hazardous situation.

Further, it is noted that since the rescue capsule is being lowered down directly from the rear end of the nacelle, the rescue capsule will be subjected to the wind and may e.g. in stormy conditions swing and collide with e.g. the wind turbine tower, whereby a dangerous situation may arise and whereby the persons inside the rescue capsule may be (further) injured.

### SUMMARY OF THE INVENTION

It has been realized by the inventor that there is a need for providing an emergency escape possibility for persons who are situated at upper levels at a wind turbine, for example persons performing various work in or on the nacelle, at the hub, at the top of the wind turbine tower, etc.

Thus, it is an objective of the invention to provide improved escape possibilities for persons at the upper level of a wind turbine.

Thus, it is also an objective to avoid accidents involving people and to provide measures to avoid fatal accidents occurring in connection with persons working in wind turbines, when for example fire incidents occur and in general to improve the safety.

It is also an objective to provide an emergency escape possibility, which ensures that the persons are evacuated in a safe and controlled manner and whereby they after being evacuated are protected from further adverse conditions.

Further, it is an objective to provide an emergency escape possibility, whereby an escape can be performed quickly, e.g. in view of the time frame that may be available after a fire has started and until it has reached a dangerous level.

Further, it is an objective to provide such an emergency escape possibility, whereby it is also possible to evacuate a person or persons that has/have been injured, e.g. persons having sustained head injury, spine injury, burn injury, heart attack, etc.

These and other objectives are achieved by the invention as explained in detail in the following.

In a first aspect, the invention relates to an emergency system for providing an emergency exit from an upper level at a wind turbine, said wind turbine comprising at least a wind turbine tower and a nacelle, said emergency system comprising
an escape unit, which in a normal condition is releasably located at a position at the nacelle of the wind turbine,
said escape unit comprising lowering means,
said escape unit being adapted for accommodating at least one person,
said escape unit comprising releasing means for providing a release from said position at said upper level and for allowing said escape unit to be lowered downwards by means of said lowering means to a lower level of said wind turbine,
said emergency system further comprising
initial guiding means for facilitating guidance of said escape unit from said position at the nacelle towards the wind turbine tower and
tower guide means for facilitating guidance of said escape unit in relation to the wind turbine tower towards said lower level of the wind turbine.

Hereby, it is achieved that in case a situation occurs at the upper level of the wind turbine, for example a threatening fire in the nacelle, which makes it vital or expedient for one or more persons present in the wind turbine to escape, such an escape may be established in a safe and expedient manner, as the person/persons may enter the escape unit, which after being released is lowered downwards to a lower level, while it is being guided in relation to the tower.

Thus, it is only required for the persons present in the nacelle and/or the tower to enter the escape unit (or being brought into the escape unit, in case of one or more persons having been injured), accommodate themselves in the escape unit, release the escape unit, whereafter no further action need be taken by the persons inside the escape unit as the escape unit in a controlled and guided manner will be lowered downwards. It is noted that the downward movement will be effected by gravity and that no further energy source may be required to perform the evacuation. Further, it is noted that in this manner all persons that are present in the nacelle and/or the tower may be evacuated all at the same time and that, thus, there is no need to decide who should be evacuated first, to prioritize persons, etc.

By use of the initial guiding means, which facilitates guidance of the escape unit from its normal position at the nacelle towards the wind turbine tower and the tower guide means for facilitating guidance of the escape unit in relation to the wind turbine tower, e.g. along the tower, towards the lower level of the wind turbine, it is achieved that the escape unit in its normal condition can be positioned at an expedient location, e.g. in view of the objective that it should be easy and uncomplicated for service persons to enter the escape unit in case of fire, while still making it possible to lower the escape unit downwards in a safe and controlled manner. On the initial route, the escape unit is guided by the initial guiding means, e.g. downwards and towards the tower, where the tower guide means takes over and guides the escape unit down, e.g. along the wind turbine tower. Thus, at essentially no positions will the escape unit be unguided.

It is noted that the guidance of the escape unit in relation to the wind turbine tower may be provided in numerous manners and variations and that it does not necessarily includes any contact with the tower itself. Essentially, it may comprise that the escape unit on its way downwards will follow a route, that the escape unit will not diverge more than a predetermined distance from said route and that it will not swing or otherwise move uncontrollably and/or hazardously.

The lowering means of the escape unit may comprise one or more lowering lines, wires, ropes or similar means.

According to an embodiment, said lower level may be at a platform or the like, e.g. in connection with a transition piece (TP) in case the wind turbine is an off-shore wind turbine, and wherein the emergency system may be configured for lowering the escape unit down to be placed at said platform or the like.

Hereby, it is achieved that the escape unit and the persons inside can be lowered down safely and end on a safe location instead of being lowered down into the sea. Hereby, it is ensured that the persons also after the tour down can be taken care of in a safe manner.

According to an embodiment, said lower level may be at a ground level and wherein the emergency system may be configured for lowering the escape unit down to be placed at the ground.

According to an embodiment, said initial guiding means for facilitating guidance of said escape unit from said position at the nacelle towards the wind turbine tower may be configured to be operative independent of the orientation of the nacelle, i.e. independent of the yaw of the nacelle.

Hereby, it is achieved that an essentially total control and guidance of the escape unit from its position at the nacelle down to the lower level can be achieved, including a transition between the initial guiding means and the tower guide means, irrespective of the angular position, i.e. the actual yawing, between the nacelle and the tower.

According to an embodiment, said tower guide means for facilitating guidance of said escape unit in relation to the wind turbine tower may be configured for providing guidance for at least a part of the distance between the nacelle and said lower level, while the escape unit is being lowered downwards.

Hereby it is achieved that the emergency escape exit including the downwards lowering can be made in a safe manner. It is noted that the guidance may be provided for essentially the whole distance between the two levels or that it may be provided for only a part of this distance, if this is preferred in some instances, for example for only the part where there is a relatively higher risk of adverse effects from the wind, etc.

According to a further embodiment, the lowering means of said escape unit may comprise at least one lowering line, i.e. one or more, which at least one lowering line is fixed to said wind turbine, which at least one lowering line has a length essentially corresponding at least to a distance from said upper level to said lower level and which cooperates with a lowering device in or at said escape unit to perform said lowering of the escape unit.

It is noted that such one or more lines connecting the escape unit and the nacelle may be arranged in such a manner that the line will follow the guidance route, meaning that when for example the escape unit has been guided towards the tower and from here is guided down along the tower, the one or more lines will suspend the escape unit in an essentially vertical direction as it will be explained in further detail below.

It is apparent that one or more of these lowering lines may be used. Further, it is apparent that such a lowering line may be cooperating with a lowering device, which preferably is located in, on or at the escape unit, e.g. in the floor or the top of the escape unit. The lowering device may instead be located at the nacelle.

According to an embodiment, the lowering device of said escape unit may comprise a winch, a capstan or the like, which is designed to discharge said at least one lowering line in consideration of a predetermined lowering speed and/or in consideration of the weight of the escape unit in order for the escape unit to be lowered at a suitable speed under influence of gravity.

In this connection it is noted that the winch, a capstan or the like of the lowering device may preferably be placed in, on or at the escape unit, e.g. in the floor or the top of the escape unit. Possibly, the winch, a capstan or the like of the lowering device may be placed on/in the nacelle with the line connected to the escape unit, whereby the lowering takes place by the winch, capstan or the like on/in the nacelle discharging the line.

According to an embodiment, the lowering means of said escape unit may in addition to said at least one lowering line comprise at least one safety line, which is fixed to said wind turbine and which has a length essentially corresponding at least to a distance from said upper level to said lower level.

Such a safety line may for example be associated with a block stop or the like and may serve to stop the lowering downwards in case there is a line fault with the at least one lowering line.

According to an embodiment, the escape unit may in said normal condition be located at said position at, on or in the nacelle, for example on top of the nacelle, at a side of the nacelle, at the end of the nacelle, below the nacelle and/or at least partly integrated with the nacelle, at which position the escape unit is connected to the nacelle by releasable fixing means, said releasable fixing means being controllable by the releasing means of the escape unit.

In accordance with a particular embodiment, the escape unit may be integrated in the nacelle and/or located inside the nacelle. In case of release, such an escape unit may be ejected from the nacelle or otherwise transferred from the nacelle to the exterior and further on to the guiding means, etc.

Further, it is noted that the escape unit may possibly be located at the wind turbine tower, e.g. at the top of this.

According to an embodiment, the escape unit may comprise manual input means, e.g. a handle, a knob or the like, which is designed for activating said releasing means for providing a release from said position at said upper level.

Thus, when the person or persons have entered the escape unit, the manual input means can be activated and from then on the further operation may be automatically performed.

According to an embodiment, the escape unit may be an essentially closed structure having an entrance, e.g. a door, a hatch or the like, for said at least one person.

Hereby, an enhanced safety is achieved since the person or persons in the escape unit will be protected from e.g. flames, smoke, heat, toxic gases, etc., as the escape unit is released and as they are being lowered downwards.

It is noted that even though an essentially closed structure, e.g. a cabin type or capsule type escape unit is a preferable embodiment for the above reasons, a partially open structure may in certain circumstances be of advantage.

According to an embodiment, the escape unit may be designed in such a manner that, when it is located at said position at the nacelle of the wind turbine, said at least one person can enter the escape unit, for example from the top of the nacelle or via a door, a hatch or the like in the nacelle.

Preferably, the person or persons can enter the escape unit directly and in an easy manner, whereby a speedy escape procedure is ensured. Furthermore, it is achieved that the escape unit can be placed at a position, which provides a convenient location, from which the wind turbine is evacuated. For example, in case the escape unit is located at the top of the nacelle, the natural route for a person or persons in the nacelle to escape would be via e.g. a hatch in the roof of the nacelle, e.g. away from the fire, which in most cases would start at a lower position and hinder that the person or persons can move downwards inside the wind turbine tower or nacelle.

According to an embodiment, the escape unit may be designed for holding said lowering line, for example in the top or in the bottom of the escape unit.

Thus, the necessary lowering line (or lines) may be stored in connection with the escape unit, and in case the escape unit is used, the line will be discharged from the escape unit as it is lowered, e.g. via a winch, a capstan or a similar device.

It is noted that the necessary lowering line (or lines) may instead be stored at or in the nacelle.

According to an embodiment, the escape unit may be designed for accommodating a number of persons corresponding to a maximum number of persons being present at any time at the upper level of the wind turbine, e.g. a maximum number of persons working simultaneously in or at the nacelle or in or at the wind turbine tower, e.g. 4-10 persons or even more.

Thus, it is ensured that there will always be sufficient escape capacity present.

It is noted that instead of one escape unit, two or more escape units can be associated with a wind turbine, if this is found preferable.

According to an embodiment, the tower guide means for facilitating guidance of said escape unit in relation to the wind turbine tower may be connected to said escape unit in such a manner that the escape unit when being lowered is positioned in relation to the wind turbine tower via said tower guide means.

As mentioned, the guidance of the escape unit in relation to the wind turbine tower may be provided in numerous manners and variations which may not necessarily include any contact with the tower itself. Essentially, it may comprise that the escape unit on its way downwards will follow a route, that the escape unit will not diverge more than a predetermined distance from said route and that it will not swing or otherwise move uncontrollably and/or hazardously.

Further, it should be mentioned that after the escape unit has been released from its normal position, it may be guided towards the tower guide means, e.g. along the side of the nacelle and possibly along the bottom of the nacelle, until it reaches an operational contact with the tower guide means, at which point the tower guide means takes care of the further guidance of the escape unit in relation to the tower. According to an embodiment, at least part of the tower guide means may be a constructional element of the escape unit, e.g. a constructional element comprising at least one movable part for interaction with the wind turbine tower or part of the wind turbine tower.

For example, the escape unit may have one or more arms that can be moved out to grip around the tower or part of the tower, when the escape unit by the initial guiding means has been guided to the tower, whereafter the escape unit can be lowered downwards while being guided by the arm or arms gripping around the tower or a part of the tower.

According to an embodiment, the tower guide means and/or a connection between said tower guide means and said escape unit may be arranged to allow for rotational movement, e.g. rotation of the nacelle with the escape unit in a normal condition being located at a position at the nacelle.

Such arrangements may be configured in various manners, e.g. to allow the escape unit to gain operational contact with the tower guide means in case the escape unit is released.

According to an embodiment, at least part of the tower guide means may in a normal condition be positioned at the top of the wind turbine tower or below the nacelle.

According to an embodiment, at least part of the tower guide means may in a normal condition be releasably positioned and can be released e.g. by the releasing means of the escape unit.

Hereby it is achieved that the escape unit can be guided automatically along the complete route and that the person or persons inside the escape unit only has to activate the release means once, when the escape unit has been entered.

In a particular embodiment, the tower guide means may be released or made operational as the escape unit gets near to the tower guide means.

Hereby it is achieved that the escape unit can be guided automatically along the complete route and that the person or persons inside the escape unit only has to activate the release means once, when the escape unit has been entered. The escape unit may for example be configured in such a manner, that when it has been guided by the initial guiding means to the tower, a sensor or the like is arranged to indicate that this position has been reached, whereafter by the system tower guide means are made operational, for example arms from the escape unit that is arranged to grip around the tower.

According to an embodiment, the tower guide means may comprise a ring-shaped or essentially ring-shaped element corresponding to the wind turbine tower.

By the terms “ring-shaped” or “essentially ring-shaped” will in this context be understood elements that may have a closed configuration, e.g. a circular form, an oval form, an elliptical form, a rectangular, quadratic, triangular, etc. form and any other suitable forms. Further, it will be understood that an open configuration may also be comprised by the terms “essentially ring-shaped”, e.g. C-shaped, U-shaped, etc. and may correspondingly comprise any suitable geometric configuration.

According to an embodiment, the ring-shaped or essentially ring-shaped element may, when released, be designed for moving downwards corresponding to the lowering of the escape unit.

According to an embodiment, the escape unit may be configured to protect a person or persons inside the escape unit, e.g. from fire and/or thermal hazards, from impact from e.g. falling objects, debris and the like.

Hereby, the safety of the person or persons can be assured, also when the escape unit is on the way down and even after the escape unit has reached the lower level. Thus, the person or persons inside the escape unit may stay in the escape unit after it has reached the lower level, until necessary rescue personnel, medical personnel etc. has arrived.

According to an embodiment, the emergency system may be configured as a retro-fit system or as a built-in system.

In a second aspect, the invention relates to a method of performing an emergency exit from an upper level of a wind turbine using an emergency system according to any of claims 1 to 22, whereby
one or more persons located at said upper level, e.g. in or on the nacelle, in or at the upper level of the wind turbine tower, or the like, enters/enter the escape unit,
activates/activate the releasing means of the escape unit, whereby the escape unit is released from its position at the nacelle and is lowered downwards by means of the lowering means to a lower level of said wind turbine, while the escape unit is guided in relation to the wind turbine tower by said initial guidance means for facilitating guidance of said escape unit from said position at the nacelle towards the wind turbine tower and by said tower guide means for facilitating guidance of said escape unit in relation to the wind turbine tower towards said lower level of the wind turbine.

Hereby, it is achieved that in case a situation occur at the upper level of the wind turbine, for example a threatening fire in the nacelle, which makes it vital or expedient for one or more persons present in the wind turbine to escape, such an escape may be established in a safe and expedient manner, as the person/persons may enter the escape unit, which after being released is lowered downwards to a lower level, while it is being guided in relation to the tower.

Thus, it is only required for the persons present in the nacelle and/or the tower to enter the escape unit (or being brought into the escape unit, in case of one or more persons having been injured), accommodate themselves in the escape unit, release the escape unit, whereafter no further action need be taken by the persons inside the escape unit as the escape unit in a controlled and guided manner will be lowered downwards. It is noted that the downward movement will be effected by gravity and that no further energy source may be required to perform the evacuation. Further, it is noted that in this manner all persons that are present in the nacelle and/or the tower may be evacuated all at the same time and that, thus, there is no need to decide who should be evacuated first, to prioritize persons, etc.

By use of the initial guiding means, which facilitates guidance of the escape unit from its normal position at the nacelle towards the wind turbine tower and the tower guide means for facilitating guidance of the escape unit in relation to the wind turbine tower, e.g. along the tower, towards the lower level of the wind turbine, it is achieved that the escape unit in its normal condition can be positioned at an expedient location, e.g. in view of the objective that it should be easy and uncomplicated for service persons to enter the escape unit in case of fire, while still making it possible to lower the escape unit downwards in a safe and controlled manner. On the initial route, the escape unit is guided by the initial guiding means, e.g. downwards and towards the tower, where the tower guide means takes over and guides the escape unit down, e.g. along the wind turbine tower. Thus, at essentially no positions will the escape unit be unguided.

According to an embodiment, said lower level may be a platform or the like near the bottom of the wind turbine tower, e.g. in connection with a transition piece (TP) in case of a sea based wind turbine, a level near or at ground level in case of a land based wind turbine, etc.

According to a further embodiment, the escape unit may be guided in relation to the wind turbine tower by said tower guide means in such a manner that the escape unit is steadied in spite of adverse wind conditions.

Hereby it is achieved that the emergency exit method may be used in virtually all weather conditions, since e.g. heavy wind or the like cannot bring the escape unit out of control, e.g. by making the escape unit swing back and forth, whereby the occupants might otherwise be injured, in particular if the escape unit should crash into the wind turbine tower.

According to a further embodiment, said escape unit may be configured to protect said one or more persons inside the escape unit, e.g. from fire and/or thermal hazards, from impact from e.g. falling objects, debris and the like, and wherein said one or more persons can stay inside the escape unit after it has reached the lower level, e.g. until rescue personnel reaches the wind turbine location, for example by means of a rescue vessel, a rescue vehicle or a rescue helicopter, depending on the wind turbine location, has reached the wind turbine location.

It is further noted that the escape unit according to an embodiment may possible be configured for being lifted up along the wind turbine tower, e.g. not necessarily in emergency situations, but possibly as a lift option or the like.

### THE FIGURES

The invention will be described in detail in the following with reference to the drawings, in which

FIGS. 1-4 show an emergency system according to a first aspect of the present invention in connection with a land-based wind turbine,

FIGS. 5-6 show an emergency system corresponding to the system shown in FIGS. 1-4, but in connection with a sea based wind turbine,

FIG. 7 shows a sea based wind turbine corresponding to the wind turbine shown in FIGS. 5 and 6 with typical hazard zones indicated,

FIG. 8 shows an emergency system corresponding to the system shown in FIGS. 5-6, wherein various further guiding means for facilitating guidance of an escape unit are illustrated,

FIG. 9 shows in a side view the top of a wind turbine, in connection with which various embodiments and various positions of an escape unit is illustrated,

FIG. 9a shows an enlarged detail of FIG. 9, indicating an initial guiding of the escape unit towards the tower and the tower guide means,

FIG. 10 shows the top of a wind turbine corresponding to FIG. 9 and with a further embodiment and position of an escape unit being illustrated,

FIG. 11 shows in a schematic manner a sectional view of the top of a wind turbine with a nacelle and an escape unit,

FIG. 12 shows in a corresponding schematic manner a sectional view of the top of a wind turbine with an escape unit positioned at the wind turbine tower,

FIGS. 13-14 show in a schematic manner a sectional view of the top of a wind turbine with a nacelle and an escape unit, corresponding to FIG. 11, and illustrating the guiding as performed by initial guiding means according to an embodiment of the invention,

FIG. 15 illustrates a nacelle with an escape unit arranged together with an escape unit fixture or frame,

FIG. 16 shows correspondingly a nacelle with an escape unit and an escape unit fixture or frame seen in another view,

FIG. 17 corresponds essentially to FIG. 16, but seen from a larger distance,

FIG. 18 corresponds essentially to FIG. 15, but wherein it is illustrated that the e.g. service persons have escaped onto the top or roof of the nacelle via a hatch,

FIGS. 19-20 show the nacelle with the escape unit and the escape unit fixture or frame seen in another view,

FIGS. 21-22 show the nacelle with the escape unit 12, seen partly from below and partly from the side, and where e.g. service persons have boarded the escape unit,

FIGS. 23-27 illustrate the downward escape movement of the escape unit down along the side of the nacelle and to the upper part of the tower,

FIGS. 28-31 illustrate the further downward escape movement of the escape unit down along the tower, and

FIGS. 32-33 illustrate the possibility that an emergency system according to an embodiment of the invention can be configured as a retro-fit system or as a built-in system.

### DETAILED DESCRIPTION

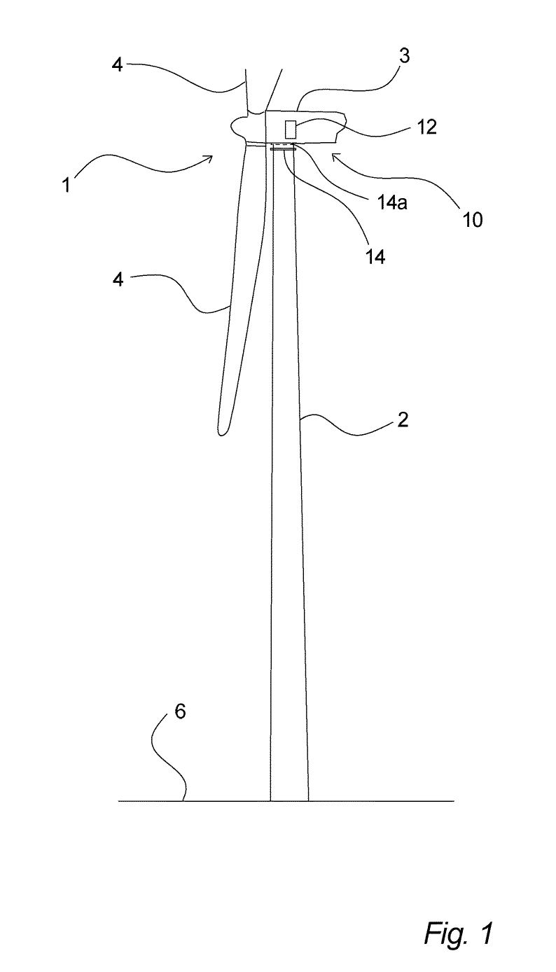

In FIGS. 1-4 is shown an emergency system or an emergency escape system, as it may also be referred to, according to a first aspect of the present invention in connection with a land-based wind turbine 1. This wind turbine 1 is shown in a schematic manner in these figures as well as the rest of the figures and this schematic presentation serves mainly for illustrative purposes. It will be understood that the emergency escape system can be used in connection with essentially all types of wind turbines and not only wind turbines of types and forms as sketched in the figures.

As it will be apparent to a skilled person, the wind turbine 1 normally comprises a wind turbine tower 2, a nacelle 3 comprising the drive train, generator and other components (not shown), and a number of rotor blades 4, which are carried by a hub connected to the drive train. As it is commonly known, the nacelle 3 is rotatably mounted on the tower 2 in order for the nacelle and thus also the rotor blades 4 to be positioned by a yawing mechanism in a direction allowing e.g. an optimal electrical output to be generated in view of the wind direction.

An escape unit 12 (which may also be referred to as a Nacelle Rescue/Escape System—“N.R.E.S”—in the following) is shown in a schematic manner placed at a position at the top of the wind turbine 1, where it is placed in normal conditions. In the shown example, the escape unit 12 is placed at a side part of the nacelle 3, where it may be connected or fixed to the nacelle 2 in various manners as it will be exemplified further below. It will be understood that the escape unit 12 may e.g. be a component that is more or less a standard component that is connected to or fixed to e.g. a nacelle, or the escape unit 12 may e.g. be a component that is to at least some degree designed to fit to the particular type, shape, brand and/or size of the nacelle, for example in such a manner that the nacelle 3 with the attached escape unit 12 has an aerodynamic shape and/or in such a manner that the escape unit 12 is to at least some degree integrated with the design of the nacelle.

Furthermore, a tower guide means 14 is illustrated in FIGS. 1-4, where in FIG. 1 such a tower guide means 14 is shown schematically placed at the top of the wind turbine tower 2 or below the nacelle 2. It is noted that generally the tower guide means is configured for guiding the escape unit 12 down, e.g. along the wind turbine tower 2 and that the tower guide means can be configured in various configurations, shapes and forms to perform this functionality. The function and various embodiments of this tower guide means 14 will be explained in further detail below. It is noted that as indicated by punctuated lines in FIG. 1 the tower guide means 14 may also be placed on or in the bottom of the nacelle 3, as indicated by the reference number 14a and as it will be exemplified below, the tower guide means 14 may be a part of the escape unit itself. Combinations hereof will also be possible. Furthermore, as it will be explained below, the exemplified emergency system comprises initial guiding means (not shown in FIGS. 1-4) for guidance of the escape unit from its normal position at the nacelle towards the wind turbine tower and the tower guide means.

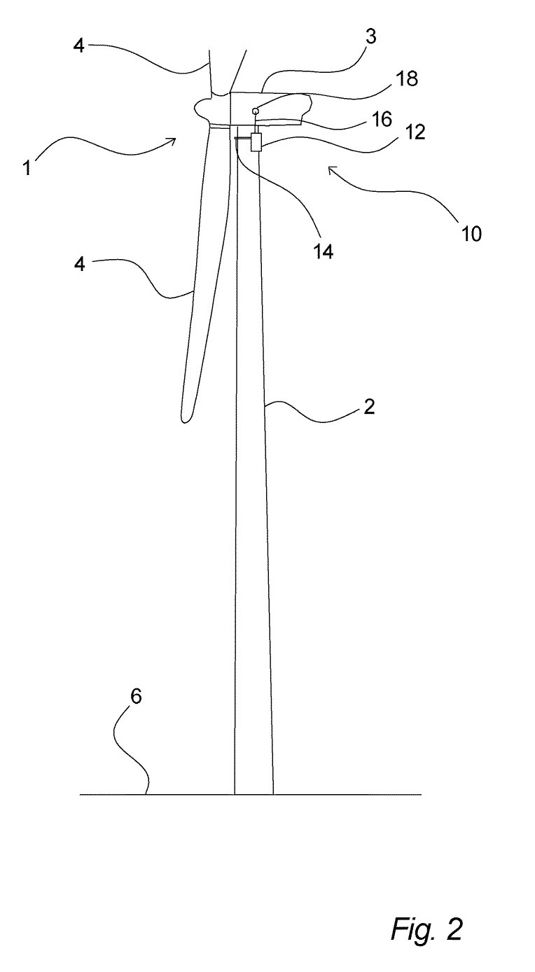

In case of an emergency, for example in case the wind turbine catches fire and one or more persons are present in the nacelle 3 or at the top of the tower 2, e.g. occupied with performing service work, etc., these persons may then enter the escape unit 12, for example via the nacelle 2, and when all are in the escape unit 12, the escape unit 12 may be released from its normal position and lowered downwards in a controlled manner, guided by the initial guiding means (not shown in FIGS. 1-4) and the tower guide means 14, as it is exemplified in FIGS. 2 to 4.

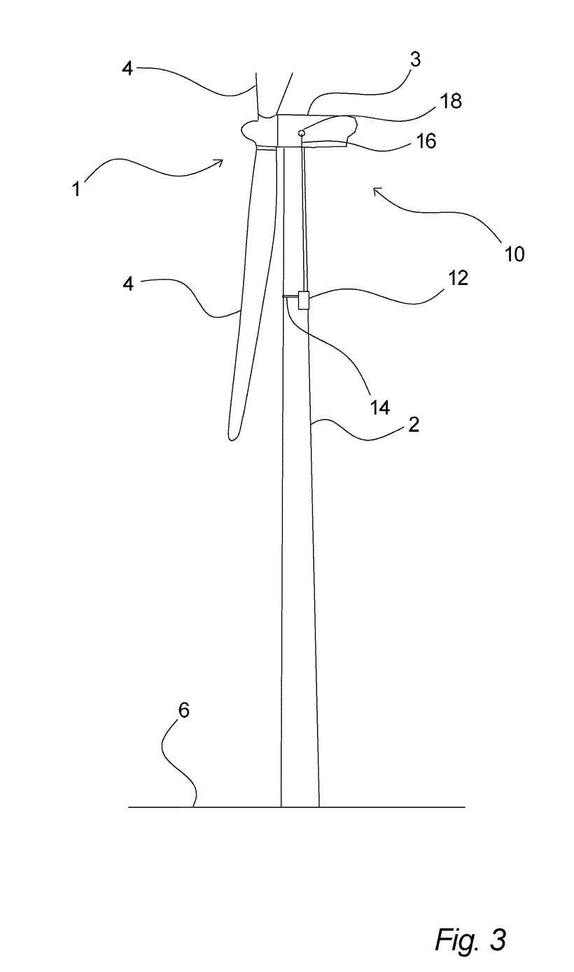

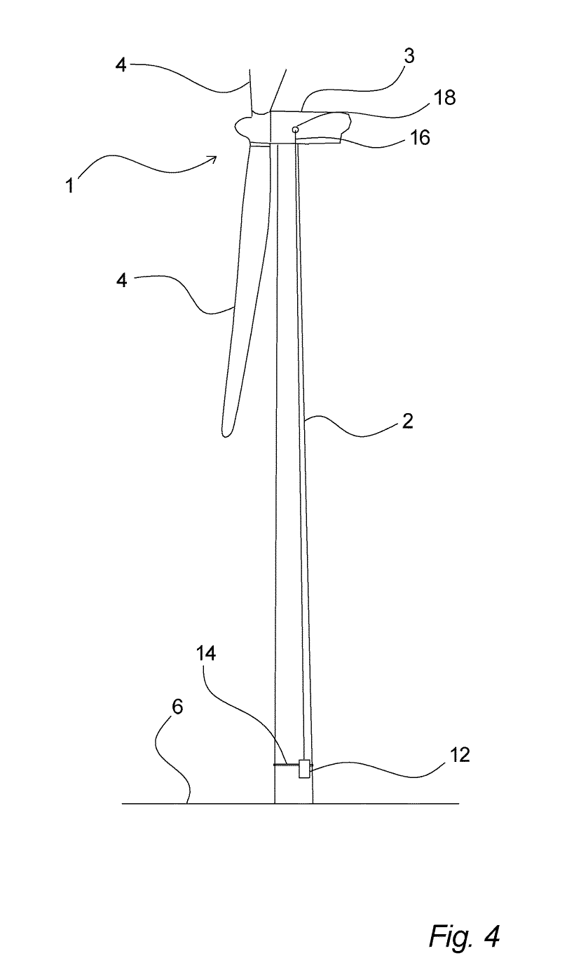

In FIG. 2 it is shown that the escape unit 12 has been released and it is now being lowered downwards by means of a line 16, which is connected to the wind turbine, e.g. at a structural part of the nacelle 3, by means of a fixing point 18 or the like. It is noted that in the following reference will be made to a line 16, but it will be apparent that by this may be understood as any corresponding means, e.g. a wire, a rope, etc. Further, it will be understood that in addition to a line 16 for lowering the escape unit 12 a further line, wire, etc. (not shown in the figures) may be applied as a safety line. Furthermore, it is shown in FIG. 2 that the tower guide means 14 is moving downwards together with the escape unit 12 and serves to maintain the escape unit in a relative position to the tower 2, which is of particular importance, when the escape unit 12 reaches lower levels as shown in FIGS. 3 and 4, where e.g. possible wind and wind gusts otherwise might cause the escape unit 12 to move uncontrollable in the horizontal directions. This might cause dangerous situations and might cause injuries to the person or persons occupying the escape unit, for example in case the escape unit should get into a swinging motion and possibly crash into the tower 2 or other structural elements.

As mentioned above, the tower guide means 14 may be configured in various manners and may be configured as shown in FIGS. 1 to 4 as an essentially closed element or as an open element, which is placed around the tower. In the normal condition it may be fixed at the top of the tower 2 and/or immediately below the nacelle 3. In connection with the release of the escape unit 12, the tower guide means 14 may be activated as well in order for it to descend downwards. The tower guide means 14 may possibly be activated by the same means that facilitate the release of the escape unit 12, or the tower guide means 14 may possibly be released by the actual movement of the escape unit 12, for example when it passes a certain position, e.g. when being guided by the initial guiding means. Other manners of performing this are possible.

As further illustrated in FIGS. 1 to 4, it is in many instances necessary that the tower guide means 14 may correspond to the form of the tower 2 and the change in form and size of the tower as the tower guide means 14 moves downwards, e.g. since the tower diameter increases downwards. This may be taken care of in various manners, e.g. by using members having flexibility, elasticity, etc. and/or by controllable means of various kinds.

As shown in FIG. 4 the escape unit 12 will end its downwards movement at a lower level at the ground 6 or near the ground, where the person or persons in the escape unit can leave the escape unit in a safe manner.

It is noted that the downwards movement of the escape unit 12 is controlled, e.g. in order not to reach too high levels of speed, but on the other hand to reach the lower level within a reasonable time period. This may be achieved in various manners, e.g. by using a lowering device, which allows the escape unit to descend by gravity alone, but where the lowering device involves e.g. a braking and/or dampening effect to avoid a high speed. It is noted that the escape unit and the emergency system in general is not relying on any power source such as batteries or the like, whereby the reliability of the system may be enhanced. Further, it is noted that the escape unit and the emergency system in general is not relying on power, e.g. electric power, hydraulic power, pneumatic power, etc. being delivered from the wind turbine in order to be functional, whereby the emergency system will be able to function in all emergency situations such as a fire accident, where the wind turbine is not operating, at least not stably.

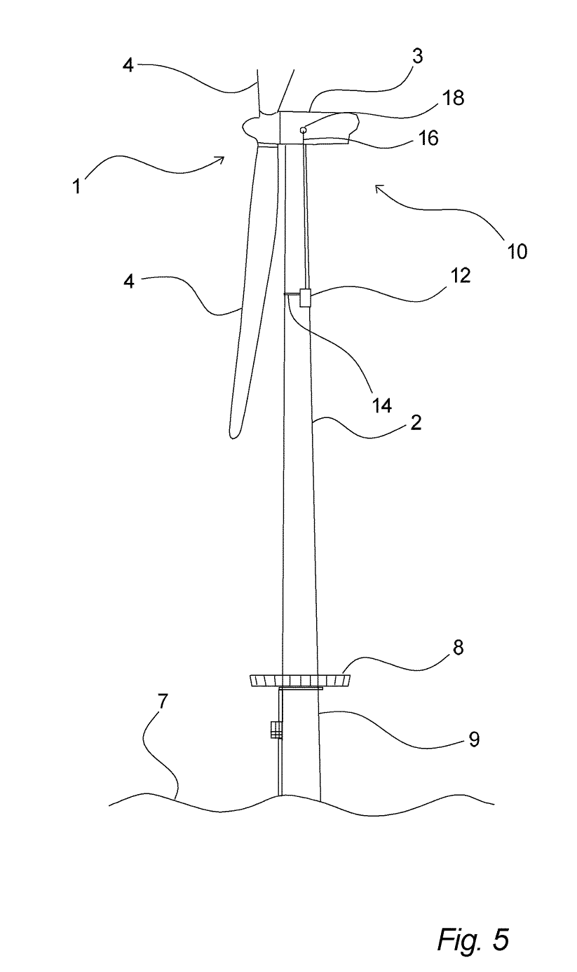

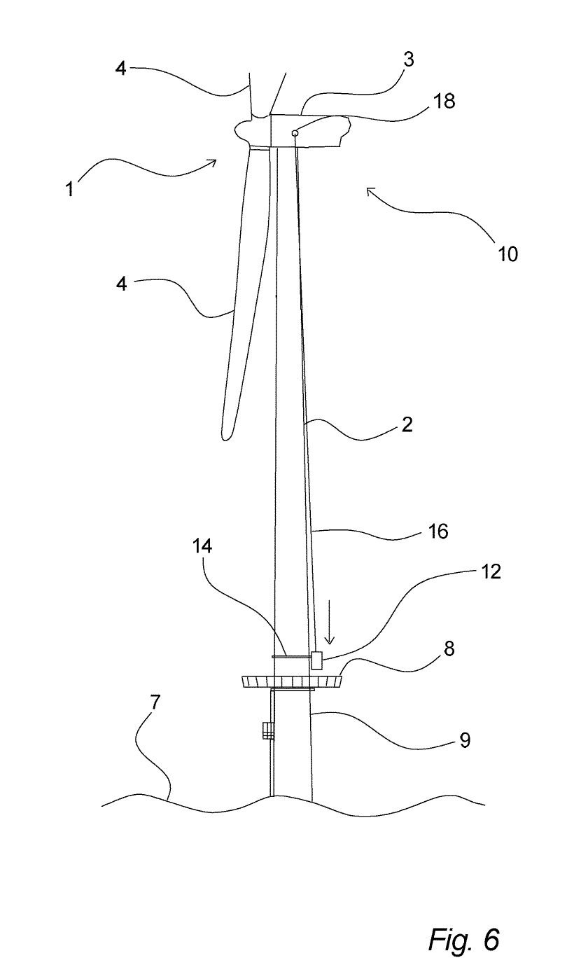

FIGS. 5-6 illustrate an emergency system corresponding to the system shown in FIGS. 1-4, but in connection with a sea based wind turbine 1 and where the essentially same elements of the emergency system are used, including initial guiding means, a tower guide means 14, which may move downwards at a rate corresponding to the descend of the escape unit 12, etc. The sea-based wind turbine may be positioned on a transition piece (TP) 9, on top of which e.g. a platform 8 is positioned. When the escape unit 12 is being lowered downwards, it will in accordance with this embodiment of the invention end at such a platform 8, where the person or persons in the escape unit 12 may safely leave the escape unit.

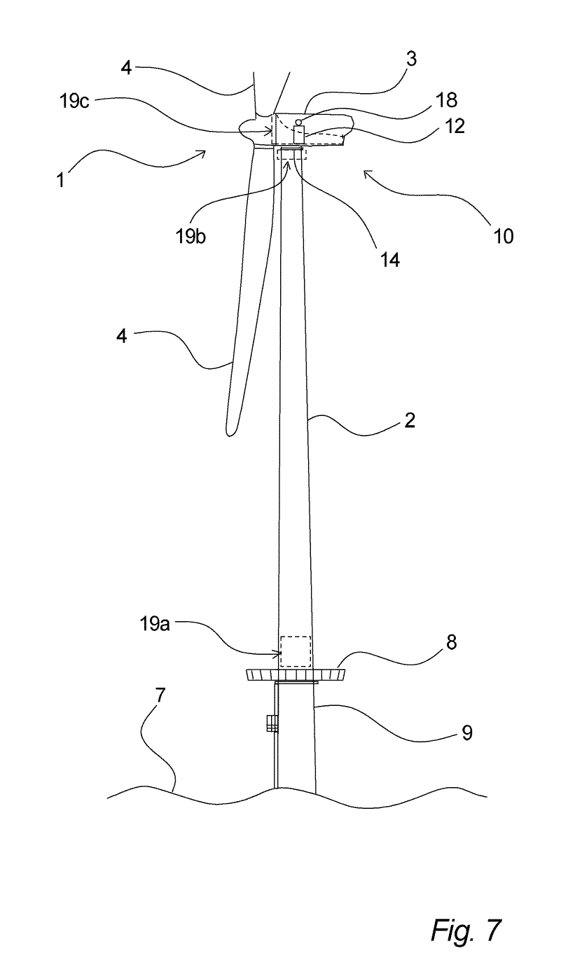

FIG. 7 shows a sea based (off-shore) wind turbine corresponding to the wind turbine shown in FIGS. 5 and 6, but in FIG. 7 with an escape unit 12 shown in a schematic manner placed at a position at the nacelle 3, e.g. at a side part of the nacelle. Furthermore, typical hazard zones are indicated in FIG. 7, i.e. zones in a wind turbine where there is a higher risk of fire. Thus, a fire may start in the zone 19a at the bottom of the wind turbine tower 2, where electrical equipment such as transformers, switchgear, control equipment, etc. typically are placed. Further, fire may start in the zone 19b at the top of the wind turbine tower 2 and below the nacelle, where typically yawing equipment, e.g. hydraulic equipment for turning the nacelle e.g. in dependence on the wind direction, in service situations, etc. is located. Furthermore, fire may start in the zone 19c in the nacelle, e.g. at the bottom part of the nacelle and at the part of the nacelle near the hub, in which zone the drive train is located and where furthermore electric as well as hydraulic equipment typically is located. As previously mentioned, a fire within these zones may evolve relatively quickly within a relatively short time after a fire has started, e.g. due to the inflammable materials present here, including inflammable liquids such as hydraulic liquids, oil products, etc., including such materials that have been spilled over time and possibly accumulated. As the fire will evolve upwards, accelerated by e.g. the chimney effect of the turbine tower, the natural route of escape for service persons working in the nacelle and/or in the upper part of the turbine tower will be upwards and via the nacelle, in case a fire is started in any of these zones. Furthermore, it is noted that even in case service persons are working in the upper part of the wind turbine tower and a fire is started in zone 19b or 19c, i.e. above the persons, an escape route down via the tower may not be hinder injury to the persons, e.g. due to the relatively time-consuming transport downwards, e.g. via stairs, manholes, etc. and due to possible smoke, toxic gases, falling debris, etc. It will thus be seen that the generally optimal escape route will be via the nacelle.

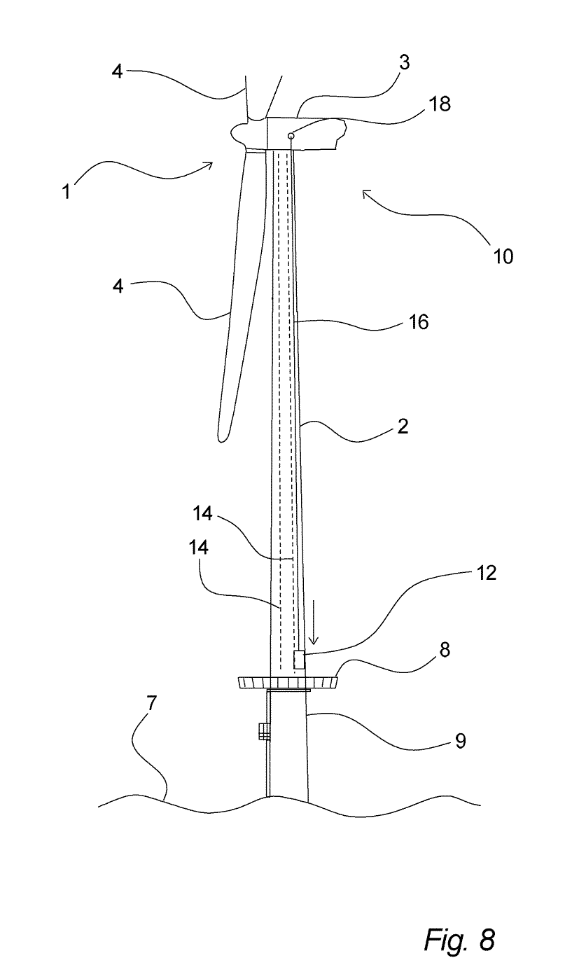

FIG. 8 shows an emergency system corresponding to the system shown in FIGS. 5-6, but wherein further forms for guiding means for facilitating guidance of an escape unit 12 are illustrated. Instead of tower guide means 14 that move downwards, the tower guide means 14 may be in the form of fixed guiding means such as rails, bars, lines, wires, etc., that extend down along the tower as indicated with punctuated lines in FIG. 8. A plurality of these may be placed on the surface of the tower and be arranged in such a manner that when an escape unit 12 is released from its normal position, it will at some point be associated with one of these rails, bars, lines, wires, etc., depending on e.g. the angular position (the yaw) of the nacelle 2, and be guided downwards.

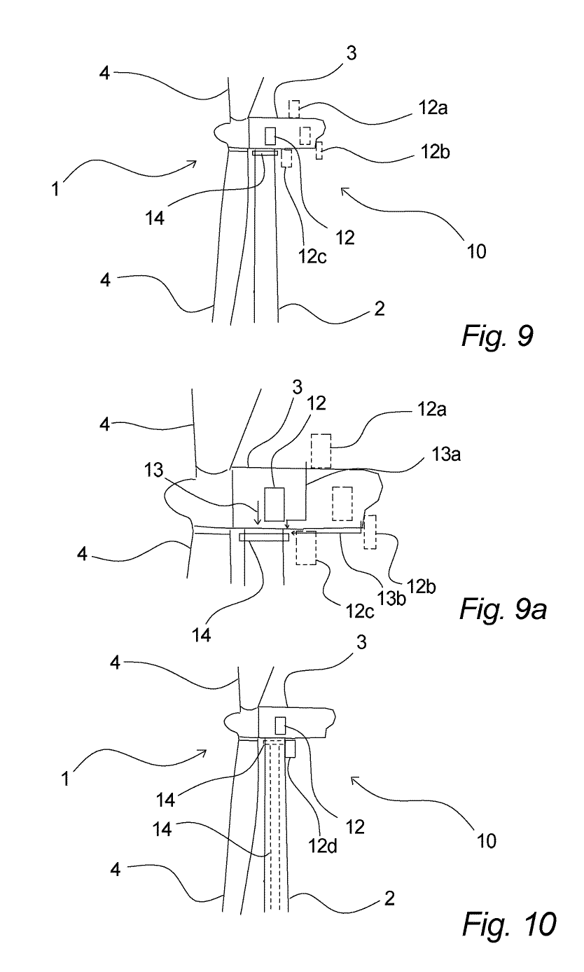

In FIG. 9 is shown a side view of the top of a wind turbine 1, in connection with which various embodiments and various positions of an escape unit 12 are illustrated.

As already mentioned the escape unit 12 may be placed at the side of the nacelle and further as shown the escape unit (12a) may be placed on top of the nacelle, the escape unit (12b) may be placed at the end of the nacelle, the escape unit (12c) may be placed beneath the nacelle, and further positions may be possible. For these positions mentioned it is apparent that the escape unit 12 is connected to the nacelle 3. It is also noted that the escape unit may be placed inside the nacelle 3, for example in such a manner that when it is released it is being ejected or otherwise transferred from inside the nacelle and towards e.g. the tower guide means and the tower. As discussed above and as it will be exemplified below, the escape unit 12 will be guided by the initial guiding means from the nacelle 3 towards the tower 2.

In FIG. 9a is shown an enlarged detail of FIG. 9, indicating such an initial guiding of the escape unit towards the tower and the tower guide means 14 after the escape unit has been released. For example, for the escape unit 12 placed at the side of the nacelle 3 it is indicated with the arrow 13 that the escape unit is guided down along the side of the nacelle 3 and possibly along the bottom of the nacelle, until it reaches an operational contact with the tower guide means 14, which from this point takes care of the further guidance of the escape unit in relation to the tower. Similarly, it is indicated for the escape unit 12a that it may initially be guided in the direction 13a down along the side of the nacelle, thereafter in the longitudinal direction of the nacelle and finally further down and possibly under the bottom of the nacelle, until it reaches an operational contact with the tower guide means 14. Also, it is indicated for the escape unit 12b with the arrow 13b that this may initially be guided slightly downwards, whereafter it is guided along the bottom of the nacelle, until it reaches an operational contact with the tower guide means 14. It is noted that these are only examples and that the initial guiding may take place in numerous manners. It will be understood that essentially the escape unit after being released via the initial guiding is brought safely towards the tower guide means, which from a point takes over as guiding means, whereby the escape unit is guided safely from release until it reaches the lower level, where the person or persons in the escape unit can leave it safely. The initial guiding may be provided by various technical means such as for example guide rails, lines, etc. but other means may be used as well.

Another embodiment is shown in FIG. 10, where it is shown that the escape unit 12d may be connected to the top of the wind turbine tower 2. For such an embodiment the persons using it may enter it via the tower, e.g. by persons in the nacelle climbing down into the tower and entering the escape unit from there. It is noted that this embodiment has the advantage that the escape unit is fixed to the tower and that there is no need to ensure that the escape unit may move downwards on any side of the tower as is the case where the escape unit is fixed to the nacelle. FIG. 10 also illustrates that tower guide means 14 may be in various forms, but it is noted that when the escape unit is fixed to the tower, rails, bars, wires, etc. may be preferable and that only one or two may be needed.

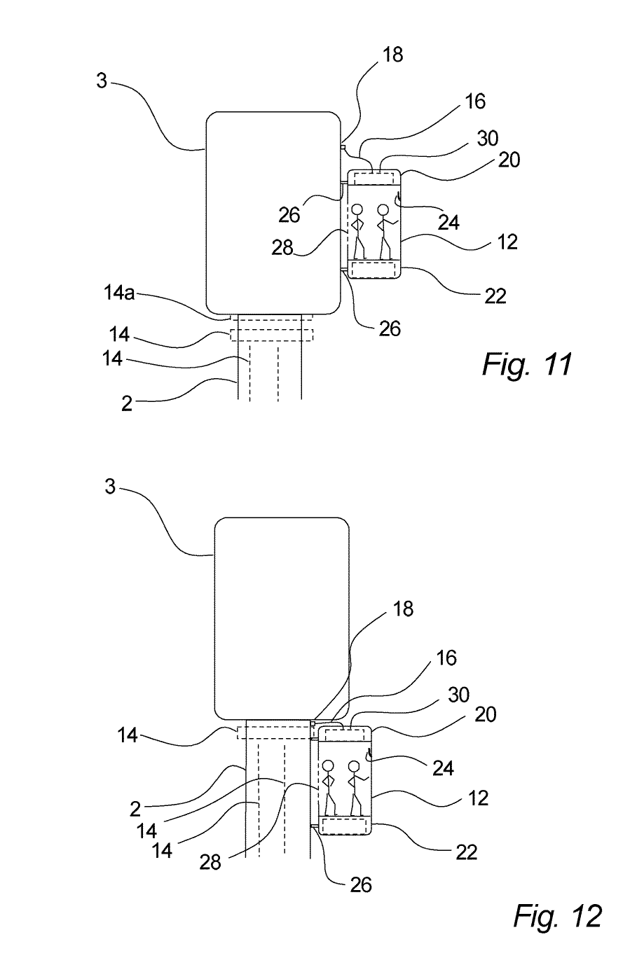

FIG. 11 shows in a schematic manner a sectional view of the top of a wind turbine with a nacelle 3 and an escape unit 12, where the escape unit is positioned at the side of the nacelle 3. The escape unit 12 may be connected to the nacelle 3 by releasable fixing means 26 in the form of couplings or the like. Further, it is shown that the escape unit 12 may have a top compartment 20, which may contain e.g. the line 16 and a winch or the like, which serves as lowering means. Further, the escape unit 12 may comprise a bottom compartment 22, which may also or instead serve to hold the line 16, a winch or the like and/or other components. The line 16 may as shown be connected to the fixing point 18 at the nacelle, e.g. at a part of the beam structure of the nacelle, which will not be easily damaged in case of e.g. fire. Further it is shown that the escape unit comprises an entrance 28, e.g. a door or the like, which in this embodiment may be placed in the side, but otherwise may be placed in order to facilitate an easy entry for the persons working in, on or at the wind turbine. Even further, manual input means 24 for activating the releasing means is illustrated, which manual input means 24 may be a handle, a knob or the like. It may be interlocked with e.g. the entrance door to the escape means in such a way that it may not be activated, before the entrance door has been safely closed. Other similar safety measures may be associated with the releasing means and the escape unit in order to improve the safety and the reliability.

In FIG. 11 it is also illustrated that tower guide means 14 may be in various forms, e.g. as an essentially closed element or as an open element, which is placed around the tower, or as fixed guiding means such as rails, bars, lines, wires, etc., that extend down along the tower. Furthermore, it is shown as also mentioned in connection with FIG. 1 that the tower guide means 14 may be placed on or in the bottom of the nacelle 3, as indicated by the reference number 14a. Thus, the tower guide means 14 will be rotating together with the nacelle. An advantage of this may be that e.g. possible service of such tower guide means 14 may be effected in an easier manner, since it may be done e.g. through the floor of the nacelle. Other advantages may be achieved by this arrangement.

FIG. 12 shows in a corresponding schematic manner a sectional view of the top of a wind turbine with an escape unit 12 positioned at the wind turbine tower 2, connected to the tower 2 in the same or corresponding manner by releasable fixing means 26 in the form of couplings or the like. The line 16 is here connected to a fixing point 18, which is at the top of the wind turbine tower. Instead, the escape unit 12 can be connected to the bottom of the nacelle 3 and otherwise configured in a manner corresponding to FIG. 11.

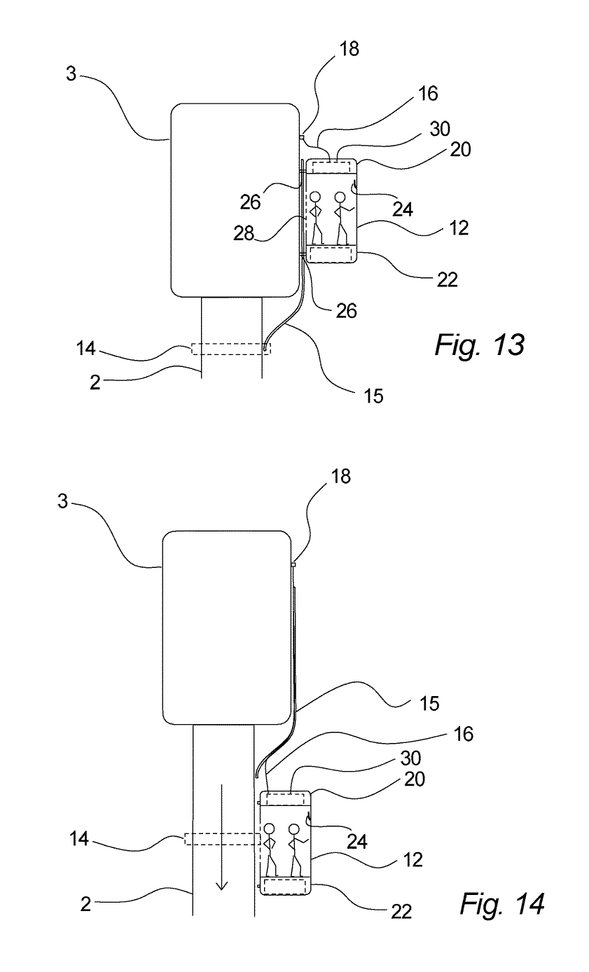

FIG. 13 shows in a schematic manner a sectional view of the top of a wind turbine corresponding to FIG. 11 with an escape unit 12 positioned at the nacelle 3 of the wind turbine. Also here, the escape unit 12 is connected to nacelle 3 by releasable fixing means 26 in the form of couplings or the like. The line 16 is also connected to the fixing point 18 and extends down to the top compartment 20, which may contain e.g. the line 16 and a winch or the like, which serves as lowering means as already described above. It is furthermore shown that an initial guiding means 15 is arranged for guiding the escape unit 12, when it is released, from its normal position at the nacelle 3 downwards and towards the tower 2.

When the escape unit 12 has been released and is moving towards the tower 2, the system is configured to deploy the tower guide means 14, which in FIGS. 13 and 14 is shown in a schematic manner. As shown in FIG. 14, the tower guide means 14 will follow the escape unit 12 down along the tower 2 and serve to guide the escape unit in relation to the tower 2. The tower guide means 14 may be configured in various manners as explained above and may for example be a part that is arranged at/around the tower 2 or the tower guide means 14 may be a part of the escape unit 2, which is arranged to perform the guiding.

It is also shown in FIG. 14 that the line 16 at least partly follows the guidance route as laid out by the initial guiding means 15 and the tower guide means 14, meaning that when for example the escape unit 12 has been guided towards the tower 2 as shown in FIG. 14 and from here is guided down along the tower 2, the line 16 will not extend directly down from the fixing point 18, which in many instances would tend to pull the escape unit 12 away from the tower. Instead, the line 16 is itself guided towards the tower 2 in such a manner that the escape unit 12 is suspended in an essentially vertical direction.

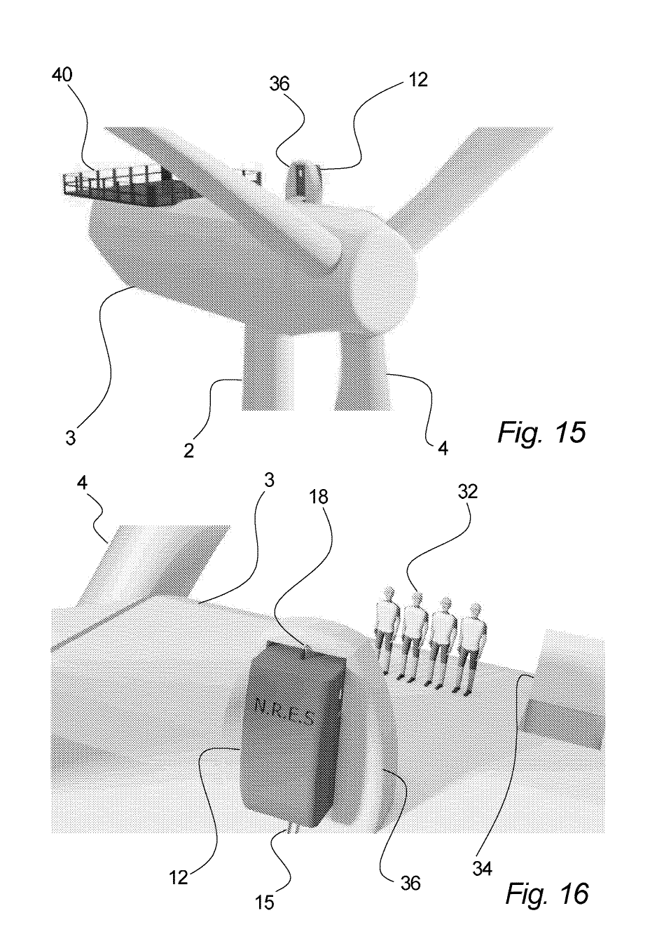

Further embodiments of an emergency system according to the invention are illustrated in FIGS. 15 to 33 as it will be further explained in the following.

In FIG. 15 a nacelle 3 on top of a wind turbine tower 2 is illustrated, where the nacelle 3 is of a relatively large type comprising a helicopter landing platform—heliport 40—at the rear of the nacelle 3. Further, it is shown that an escape unit 12 is arranged together with an escape unit fixture or frame 36, e.g. a part that is fixed to the nacelle 3, at a position on top of the nacelle 3 and near the side of the nacelle.

FIG. 16 shows an essentially corresponding nacelle 3 with an escape unit 12 and an escape unit fixture or frame 36, seen partly from above and partly from the other side as compared to FIG. 15. Here, it is shown that the nacelle 3 has a hatch 34 or the like in its upper part. As explained above, the e.g. service persons 32 that are working in the nacelle 3 or the tower 2 can in an emergency situation escape via the hatch 34 to the top (roof) of the nacelle 3 in order to go aboard the escape unit 12. This is illustrated in FIG. 16, i.e. that all service persons 32 working simultaneously in the wind turbine can as a group get aboard the escape unit and be evacuated in a safe and protected manner.

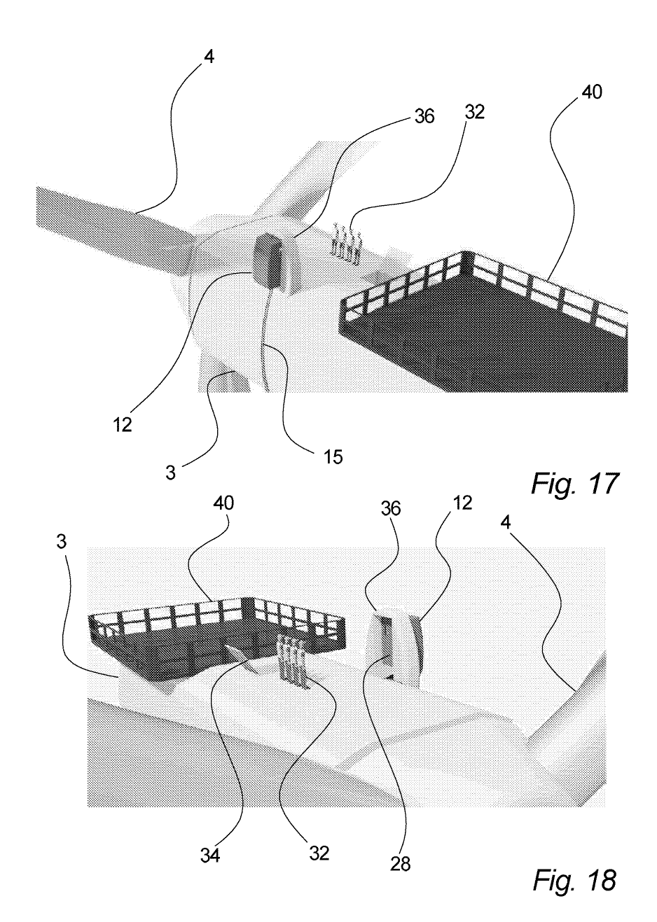

FIG. 17 corresponds essentially to FIG. 16, but seen from a larger distance. Thus, in FIG. 17 the initial guiding means 15 is also illustrated, leading from the escape unit fixture or frame 36 down along the side of the nacelle 3 and towards the tower 2.

FIG. 18 corresponds essentially to FIG. 15, but where also it is illustrated that the e.g. service persons 32 have escaped onto the top or roof of the nacelle 3 via the hatch 34 and are now ready all to enter the escape unit 12 via the entrance 28. In this embodiment it is shown that the escape unit fixture or frame 36 is configured as a fixed part with a central opening, corresponding to the entrance 28, through which the service persons 32 can get aboard the escape unit 12.

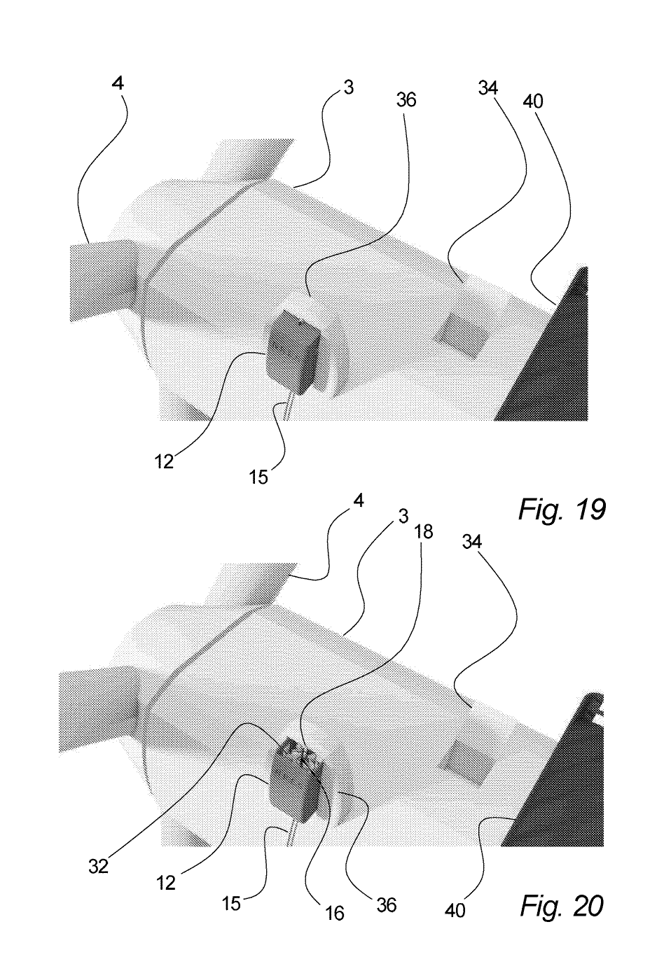

FIGS. 19 and 20 show the nacelle 3 with the escape unit 12 and the escape unit fixture or frame 36 seen partly from above and partly from the side, and where the e.g. service persons 32 have boarded the escape unit 12, ready to be evacuated downwards in a safe and protected manner. In FIG. 20 the top of the escape unit 12 has been removed for illustrative purposes, showing the persons 32 inside the escape unit 12. Further, it is shown that the fixing point 18 for the line 16 is arranged at the top of the escape unit fixture or frame 36, which line 16 is arranged to pass down inside the escape unit 12 as it will be explained in the following.

FIGS. 21 and 22 also show the nacelle 3 with the escape unit 12 (the “N.R.E.S” as mentioned above) and the escape unit fixture or frame 36, but here seen partly from below and partly from the side, and where the e.g. service persons 32 have boarded the escape unit 12, ready to be evacuated downwards. Thus, the initial guiding means 15 is shown, and in FIG. 22 the bottom of the escape unit 12 has been removed for illustrative purposes in order to show a winch or the like 23, e.g. with drums for storing and unwinding of the at least one line, wire or the like 16, which is arranged in a bottom compartment of the escape unit 22 and which serves as explained above to control the downward movement of the escape unit 12.

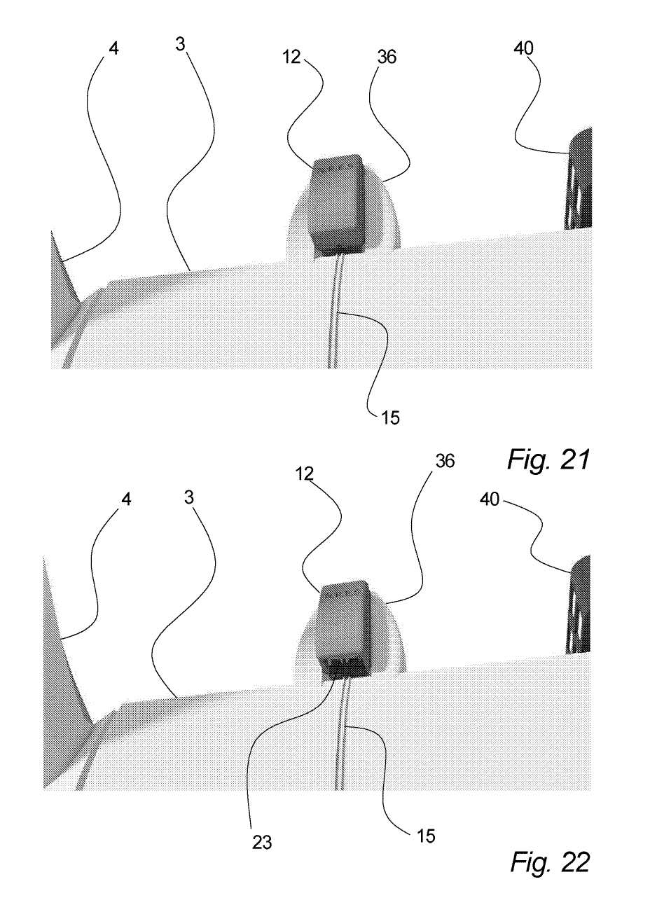

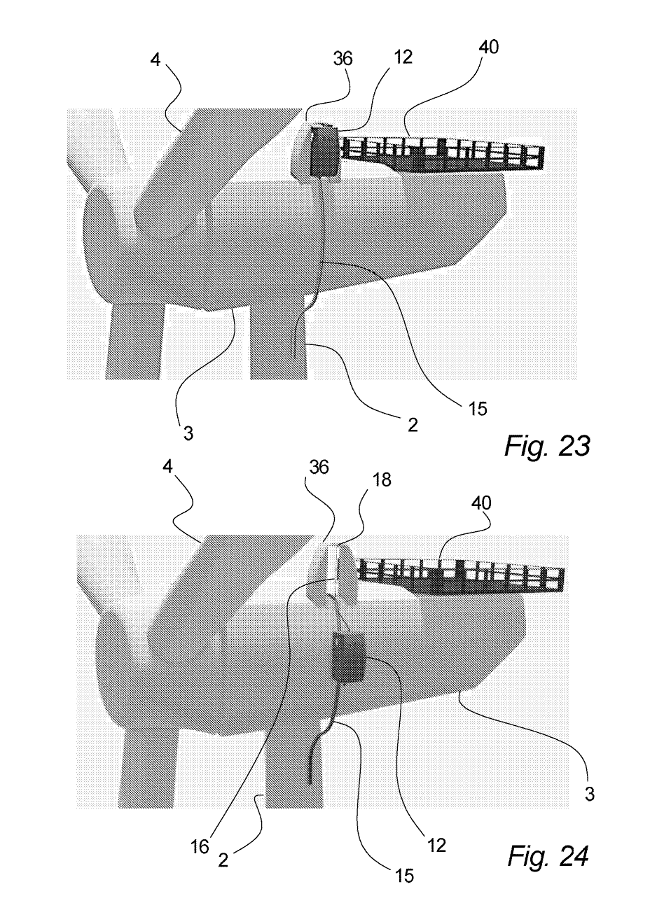

The downward movement of the escape unit 12 will be further explained with reference to FIGS. 23 to 27, which all show the nacelle 3 seen from the side and from a position forward of the nacelle 3. In FIG. 23 the service persons have boarded the escape unit 12, which is ready to initiate the escape, when it is activated, e.g. by one of the persons inside operating the input means to the releasing means.

FIG. 24 shows such a subsequent situation, where the escape unit 12 has begun the downward movement, guided by the initial guiding means 15 and lowered by means of the at least one line, wire or the like 16. This at least one line, wire or the like 16 is as explained above and as shown here fixed to the fixing point 18, from which it passes down to the initial guiding means 15 and to the top of the escape unit 12. The at least one line, wire or the like 16 passes through the escape unit 12 to the winch or the like 23 (see FIG. 22) in the bottom of the escape unit, where the line 16 is unwound from a drum or the like in a controlled manner.

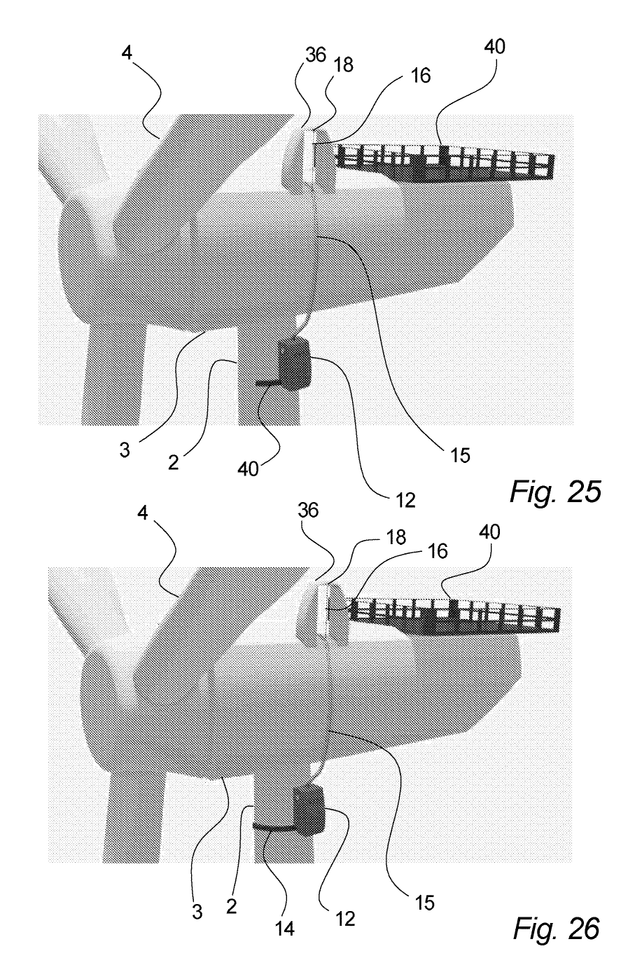

FIG. 25 shows such a further subsequent situation, where the escape unit 12 has been guided by the initial guiding means 15 down to the top of the tower 2, with the at least one line, wire or the like 16 “following” the initial guiding means 16 on the way down in order to ensure that the escape unit 12 is suspended in an optimal manner. In FIG. 25 it is further shown that the tower guide means 14 is in the form of arms or the like, e.g. one on each side of the escape unit or the like, which arms or the like from the escape unit 12 can move out and act to guide the escape unit 12 on its way down along the tower 2.

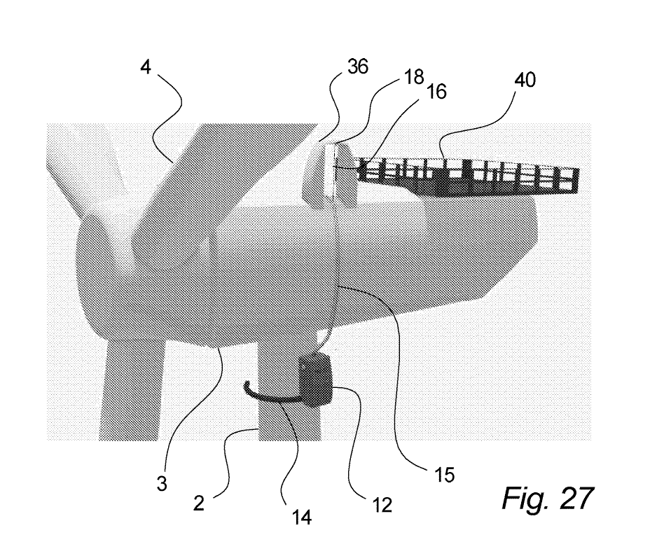

This is further illustrated in FIGS. 26 and 27, where it is shown in FIG. 27 that such arms may be configured to adapt to the various dimensions of the tower, e.g. to correspond to the dimension of the tower at the top as well as to the usually larger dimensions nearer to the bottom of the tower 2.

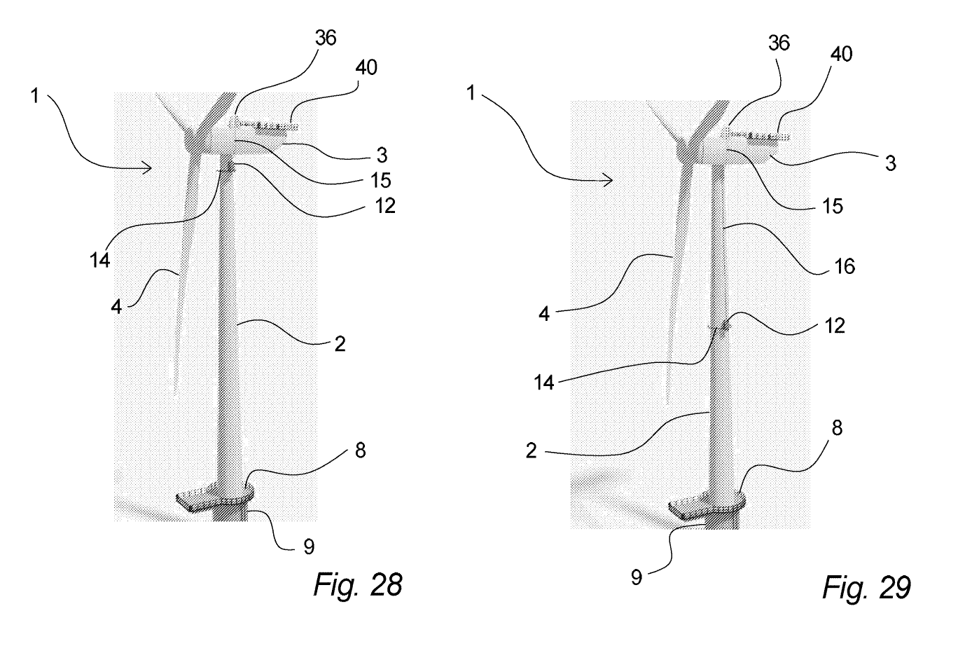

The downward movement of the escape unit 12 is further illustrated in FIGS. 28 to 31, where an off-shore wind turbine 1 is illustrated, essentially corresponding to the wind turbine as it has been explained above in connection with FIGS. 15 to 27, but here shown with a transition piece (TP) 9 and a platform or the like 8 at the level essentially between the transition piece 9 and the tower 2. In FIG. 28 it is shown that the escape unit 12 has reached a position essentially as described above in connection with FIG. 27, e.g. with the escape unit 12 at the top of the tower 2 and with the tower guide means 14 having been deployed to e.g. grip around the tower and in general control or guide the route down along the tower 2.

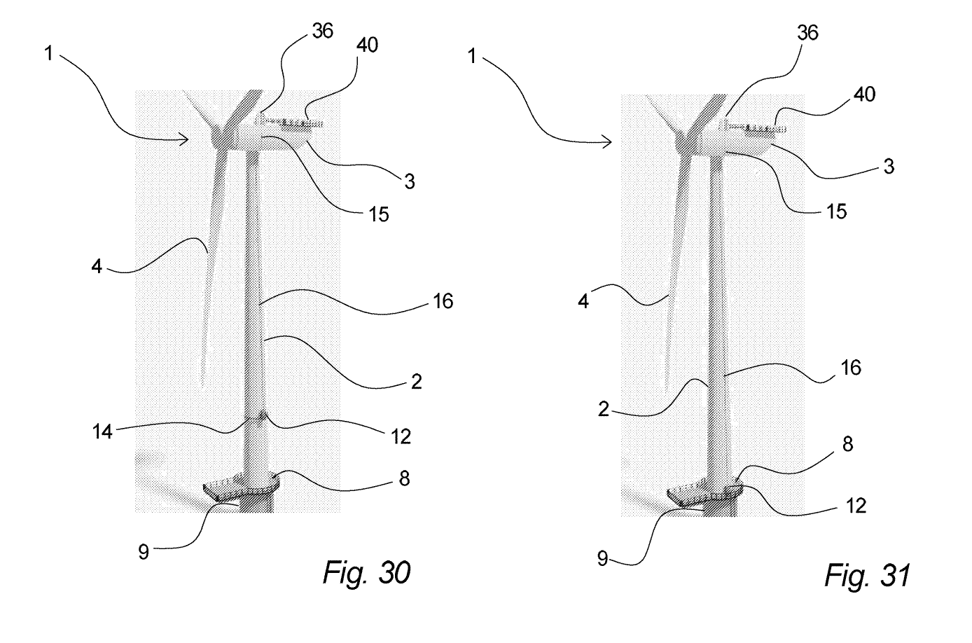

In FIG. 29 it is shown that the escape unit 12 has reached a position near the middle part of the tower 2, in FIG. 30 it is shown that the escape unit 12 has reached a position nearer the bottom of the tower 2 and in FIG. 31 it is shown that the escape unit 12 has reached the platform or the like 9. Here, the persons inside the escape unit 12 can stay as it has been explained above, until rescue personnel arrive, e.g. by ship, boat, helicopter, etc. which may take a while, in particular in connection with off shore wind parks, etc. Thus, the persons can stay in the escape unit 12 and stay protected here from the e.g. cold, windy and/or wet conditions, protected from falling debris, smoke, gas, etc. as it has been explained above, until they can be rescued and transported away in a safe manner.

It is noted that the escape unit 12 according to an embodiment may possible be configured for being lifted up along the wind turbine tower 2, e.g. not necessarily in emergency situations, but possibly as a lift option or the like.

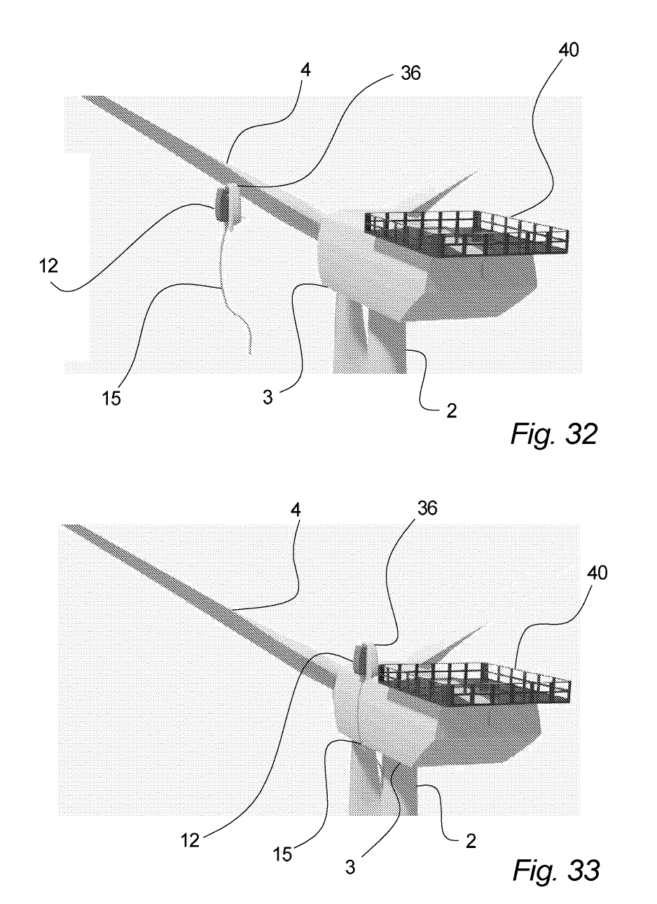

Finally, FIGS. 32 and 33 show a nacelle 3 with rotor blades 4 and the top part of the tower 2 in order to illustrate the possibility that an emergency system according to an embodiment of the invention can be configured as a retro-fit system, e.g. where the components such as an escape unit 12, an escape unit fixture or frame 36 and the initial guiding means 15, etc. can be fitted to an existing wind turbine, which furthermore can be performed with various forms and configurations of the components, e.g. in order to be suitable for the various types, forms, etc. of the existing wind turbines. It will be understood, though, that the emergency system according to the invention naturally can be installed in connection with the actual building of the wind turbines.

In FIGS. 15 to 33 the emergency system and its components have been shown in particular embodiments, but it will be understood that all embodiments and/or variations, possibilities, modifications as described above and/or as specified in the appended claims may be used in any combination with the embodiments shown in FIGS. 15 to 33. Thus, it will be understood that the escape unit may be placed at other locations in, on or at the nacelle, including as a more or less integrated part, that the escape unit fixture or frame may be configured in a multitude of manners, that the initial guide means may be configured and varied in a multitude of manners, etc.

It will be understood that the invention is not limited to the particular examples described above and as shown in the drawings, but may be modified in numerous manners within the scope of the invention as specified in the claims. Further, it will be understood that the various modifications and details disclosed above and in the drawings may be combined in a multitude of combinations within the scope of the invention.

### LIST OF REFERENCES

1 Wind turbine
2 Wind turbine tower
3 Nacelle
4 Rotor blade
6 Ground
7 Sea level
8 Platform
9 Transition piece
10 Emergency system
12 Escape unit
12a-12d Escape unit in various positions in normal conditions
13, 13a, 13b Initial guiding of escape unit
14 Tower guide means
15 Initial guiding means
16 Line, wire or the like
18 Fixing point for line
19a-c Typical hazard zones
20 Top compartment of escape unit
22 Bottom compartment of escape unit
23 Winch, capstan or the like
24 Manual input means, e.g. a handle, a knob or the like, for activating releasing means
26 Releasable fixing means
28 Entrance to escape unit
30 Lowering means
32 Persons, service personnel, etc.
34 Hatch or the like in nacelle
36 Escape unit fixture, frame or the like
40 Heliport

1. An emergency system for providing an emergency exit from an upper level at a wind turbine, said wind turbine comprising at least a wind turbine tower and a nacelle, said emergency system comprising:
an escape unit, which in a normal condition is releasably located at a position at the nacelle of the wind turbine,
said escape unit comprising lowering means,
said escape unit being adapted for accommodating at least one person,
said escape unit comprising releasing means for providing a release from said position at said upper level and for allowing said escape unit to be lowered downwards by means of said lowering means to a lower level of said wind turbine,
said emergency system further comprising:
initial guiding means for facilitating guidance of said escape unit from said position at the nacelle towards the wind turbine tower and
tower guide means for facilitating guidance of said escape unit in relation to the wind turbine tower towards said lower level of the wind turbine.

2. The emergency system according to claim 1, wherein said low er level is at a platform and wherein the emergency system is configured for lowering the escape unit down to be placed at said platform.

3. The emergency system according to claim 1, wherein said lower level is at a ground level and wherein the emergency system is configured for lowering the escape unit down to be placed at the ground.

4. The emergency system according to claim 1, wherein said initial guiding means for facilitating guidance of said escape unit from said position at the nacelle towards the wind turbine tower are configured to be operative independent of the orientation of the nacelle.

5. The emergency system according to claim 1, wherein said tower guide means for facilitating guidance of said escape unit in relation to the wind turbine tower is configured for providing guidance for at least a part of the distance between the nacelle and said lower level, while the escape unit is being lowered downwards.

6. The emergency system according to claim 1, wherein the lowering means of said escape unit comprises at least one lowering line, which is fixed to said wind turbine, which has a length essentially corresponding at least to a distance from said upper level to said lower level and which cooperates with a lowering device in or at said escape unit to perform said lowering of the escape unit.

7. The emergency system according to claim 6, wherein the lowering device of said escape unit comprises a winch or a capstan which is designed to discharge said at least one lowering line in consideration of a predetermined lowering speed and/or in consideration of the weight of the escape unit.

8. The emergency system according to claim 6, wherein the lowering means of said escape unit in addition to said at least one lowering line comprises at least one safety line, which is fixed to said wind turbine and which has a length essentially corresponding at least to a distance from said upper level to said lower level.

9. The emergency system according to claim 1, wherein said escape unit in said normal condition is located at said position at, on or in the nacelle at which position the escape unit is connected to the nacelle by releasable fixing means, said releasable fixing means being controllable by the releasing means of the escape unit.

10. The emergency system according to claim 1, wherein said escape unit comprises manual input means which is designed for activating said releasing means for providing a release from said position at said upper level.

11. The emergency system according to claim 1, wherein said escape unit is an essentially closed structure having an entrance for said at least one person.

12. The emergency system according to claim 1, wherein said escape unit is designed in such a manner that, when it is located at said position at the nacelle of the wind turbine, said at least one person can enter the escape unit.

13. The emergency system according to claim 6, wherein said escape unit is designed for holding said at least one lowering line.

14. The emergency system according to claim 1, wherein said escape unit is designed for accommodating a number of persons corresponding to a maximum number of persons being present at any time at the upper level of the wind turbine.

15. The emergency system according to claim 1, wherein said tower guide means for facilitating guidance of said escape unit in relation to the wind turbine tower are connected to said escape unit in such a manner that the escape unit when being lowered is positioned in relation to the wind turbine tower via said tower guide means.

16. The emergency system according to claim 15, wherein at least part of said tower guide means is a constructional element of the escape unit comprising at least one movable part for interaction with the wind turbine tower or part of the wind turbine tower.

17. The emergency system according to claim 15, wherein said tower guide means and/or a connection between said tower guide means and said escape unit is arranged to allow for rotational movement.

18. The emergency system according to claim 15, wherein at least part of said tower guide means in a normal condition is positioned at the top of the wind turbine tower or below the nacelle.

19. The emergency system according to claim 15, wherein at least part of said tower guide means in a normal condition is releasably positioned and can be released by the releasing means of the escape unit.

20. The emergency system according to claim 15, wherein said tower guide means comprises a ring-shaped or essentially ring-shaped element corresponding to the wind turbine tower.

21. The emergency system according to claim 20, wherein said ring-shaped or essentially ring-shaped element when released is designed for moving downwards corresponding to the lowering of the escape unit.

22. The emergency system according to claim 1, wherein the escape unit is configured to protect a person or persons inside the escape unit.

23. The emergency system according to claim 1, wherein the emergency system is configured as a retro-fit system or as a built-in system.

24. A method of performing an emergency exit from an upper level of a wind turbine using an emergency system according to claim 1, whereby
one or more persons located at said upper level enters/enter the escape unit,
activates/activate the releasing means of the escape unit, whereby the escape unit is released from its position at the nacelle and is lowered downwards by means of the lowering means to a lower level of said wind turbine, while the escape unit is guided in relation to the wind turbine tower by said initial guidance means for facilitating guidance of said escape unit from said position at the nacelle towards the wind turbine tower and by said tower guide means for facilitating guidance of said escape unit in relation to the wind turbine tower towards said lower level of the wind turbine.

25. The method according to claim 24, wherein said lower level is a platform near the bottom of the wind turbine tower.

26. The method according to claim 24, wherein said escape unit is guided in relation to the wind turbine tower by said tower guide means in such a manner that the escape unit is steadied in spite of adverse wind conditions.

27. The method according to claim 24, wherein said escape unit is configured to protect said one or more persons inside the escape unit, and wherein said one or more persons can stay inside the escape unit after it has reached the lower level.
